(19) United States
(12) Patent Application Publication
(10) Pub. No.: US 2014/0175319 A1
(43) Pub. Date: Jun. 26, 2014

(54) MULTI-SECTION VALVE BODIES HAVING FACE SEALS

(71) Applicant: FISHER CONTROLS INTERNATIONAL LLC, Marshalltown, IA (US)

(72) Inventor: Brandon Wayne Bell, Marshalltown, IA (US)

(73) Assignee: FISHER CONTROLS INTERNATIONAL LLC, Marshalltown, IA (US)

(21) Appl. No.: 13/722,465

(22) Filed: Dec. 20, 2012

(51) Int. Cl. F16K 13/00

(52) U.S. Cl. CPC F16K 13/00
USPC 251/367

(57) ABSTRACT

Multi-section valve bodies having face seals are described herein. An example multi-section valve body includes a first body defining a first portion of a valve passageway and having a fluid flow axis, the first body having a first sealing surface substantially perpendicular to the fluid flow axis and a first annular wall substantially parallel to the fluid flow axis, the first body having an annular cavity defined in the first sealing surface to receive a seal. The example valve also includes a second body having a bore defining a second portion of the valve passageway, the second body having a first end surface to be substantially parallel to the first sealing surface, wherein the first sealing surface is to engage the first end surface and the first annular wall is to extend into the bore of the second body when the first body is coupled to the second body.

### FIELD OF THE DISCLOSURE

The present disclosure relates generally to multi-section valve bodies and, more specifically, to multi-section valve bodies having face seals.

### BACKGROUND

Control valves (e.g., sliding stem valves, rotary valves, axial flow valves, globe valves, etc.) are commonly used in industrial processes, such as oil and gas pipeline distribution systems and chemical processing plants, to control the flow of process fluids. Some known control valves include a valve body comprised of multiple sections (e.g., pieces, portions, components, parts, bodies). Ball valves are an example of control valves that are often composed of multiple sections. Ball valves are favored in certain applications because they are extremely durable, provide tight shutoff, and are effective in high flow systems.

Known ball valves utilize a ball (e.g., a spherically-shaped disk, a flow control member, etc.) having a hole (e.g., a bore, a port, a passageway) through its center and disposed within a passageway of a valve body. A shaft is attached to the ball via an aperture in the valve body and is to rotate the ball between an open position and a closed position. In the open position, the ball is rotated such that the hole in the ball aligns with both ends of the valve. In the closed position, the ball is rotated such that the hole is perpendicular to the ends of the valve and the fluid passageway through the valve is blocked.

The ball in a ball valve has a larger diameter than a diameter of the valve passageway. Thus, ball valves are usually manufactured and assembled in sections around the ball, especially in the instance with larger ball valves where price and practicality more greatly affect the manufacturing and assembly processes. Some known ball valves have three main body sections: a middle body section, which includes the ball, and two tailpiece body sections on opposing sides of the body section. The tailpieces must properly seal against the body section to prevent the leakage of process fluids. The tailpieces include flanges having faces that are coupled or clamped to respective ends of the body section. The tailpieces also include outside flanges that may be coupled or clamped to the end of a pipe such as, for example, in a piping distribution system.

Many known tailpieces also utilize male extensions (e.g., sleeves, annular protuberances, circular protrusions, etc.) that extend into the passageway or bore of the body section. Outer annular walls of the male extensions sealingly engage an inner wall of the passageway or bore of the body section to align and seal the valve from leakage at each joint (e.g., the boundary between a tailpiece and the body). The annular walls include glands (e.g., grooves, cavities, etc.) to hold a seal such as, for example, an o-ring. The geometry (e.g., profile) of the gland is to retain the seal during assembly such as, for example, during a vertical assembly operation. Compression of the o-ring creates a seal between the annular walls of the male extensions and the inner surface of the body section is to prevent the leakage of process fluid outside of the valve.

However, problems exist with the above-mentioned sealing interface (i.e., the boundary between the annular wall and the inner surface of the body section). The seal is achieved by squeezing the o-ring disposed within the glands between the annular wall and the inner surface of the body section and, thus, the tolerances between these two surfaces must be very tight. A relatively narrow range of compression of the o-ring is needed to ensure proper sealing. Therefore, a gap between the annular wall and the inner surface of the body section must be large enough for the parts to be assembled and small enough to ensure proper o-ring compression (e.g., squeeze), but not overly tight such that an end of the body section catches and damages the o-ring, which can be a problem during the assembly process. Also, during operation, it is known that pressure from the process fluids can force a portion of the o-ring seal (or the entire o-ring) out of the gland and down into the gap between the annular wall and the inner surface of the body section. Thus, proper o-ring squeeze is lost and a leak path forms in the gap.

To ensure proper alignment, these known ball valves are often assembled vertically. Also, larger valves with heavy components are assembled vertically by using a crane or other mechanical device to assist in lifting and aligning the three main body sections. However, during assembly of these large and heavy body sections, it is difficult to detect if the o-ring has been damaged (e.g., torn, ripped, cut). As the body section slides down over the male extension of the first tailpiece, the relative movement may shear the o-ring and damage it within the annular gland.

Although these inefficiencies are described in relation to a ball valve body, these problems can occur with any valve having multiple body sections and, more specifically, with valves having male end sealing surfaces.

### SUMMARY

In one example, an apparatus includes a first body defining a first portion of a valve passageway and having a fluid flow axis, the first body having a first sealing surface substantially perpendicular to the fluid flow axis and a first annular wall substantially parallel to the fluid flow axis, the first body having an annular cavity defined in the first sealing surface to receive a seal. The example apparatus includes a second body having a bore defining a second portion of the valve passageway, the second body having a first end surface to be substantially parallel to the first sealing surface, wherein the first sealing surface is to engage the first end surface and the first annular wall is to extend into the bore of the second body when the first body is coupled to the second body.

In another example, a valve body includes a first tail portion defining a first portion of a passageway and having a first flange with a first annular groove, the first annular groove extending into the first flange in a direction substantially parallel to a longitudinal axis of the passageway, the first tail portion having a first annular wall section extending from the first flange. The valve body also includes a second tail portion defining a second portion of the passageway and having a second flange with a second annular groove, the second annular groove extending into the second flange in a direction substantially parallel to the longitudinal axis of the passageway, the second tail portion having a second annular wall section extending from the second flange. The valve body also includes a valve portion having a bore defining a third portion of the passageway, the valve portion having a first end surface and a second end surface opposite the first end surface, wherein the first flange engages the first end surface and the first annular wall section extends into at least a portion of the bore, and wherein the second flange engages the second end surface and the second annular wall section extends into at least a portion of the bore.

In yet another example, an apparatus includes a first body defining a first portion of a valve passageway and having a fluid flow axis, the first body having a first sealing surface substantially perpendicular to the fluid flow axis and a first male extension extending from the first sealing surface. The apparatus also includes a second body defining a second portion of the valve passageway, the second body having a second sealing surface substantially perpendicular to the fluid flow axis and a second male extension extending from the second sealing surface. The apparatus also includes a third body having a bore defining a third portion of the valve passageway, the third body having a first end surface to be substantially parallel to the first sealing surface and a second end to be substantially parallel to the second sealing surface. The apparatus also includes first means for sealing to prevent a flow of fluid between the first sealing surface of the first body and the first end of the third body when the first body is coupled to the third body and second means for sealing to prevent the flow of fluid between the second sealing surface of the second body and the second end of the third body when the second body is coupled to the third body.

### BRIEF DESCRIPTION OF THE DRAWINGS

FIG. 1A illustrates an exploded cross-sectional view of a known multi-section valve.

FIG. 1B illustrates a cross-sectional view of the known valve of FIG. 1A assembled.

FIG. 1C is an enlarged portion of the cross-sectional view of FIG. 1B.

FIG. 2A illustrates an exploded cross-sectional view of an example multi-section valve in accordance with the teachings of this disclosure.

FIG. 2B illustrates a cross-sectional view of the example valve of FIG. 2A.

FIG. 2C is an enlarged portion of the cross-sectional view of FIG. 2B.

FIG. 3 is an enlarged portion of the example valve of 2A with an alternative gland profile.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

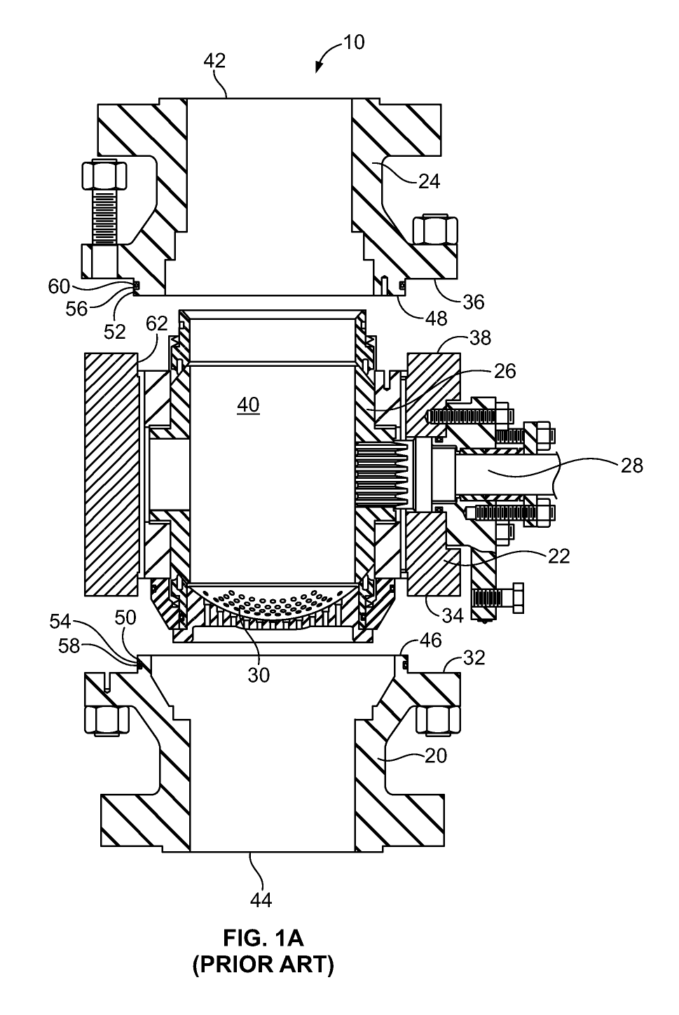

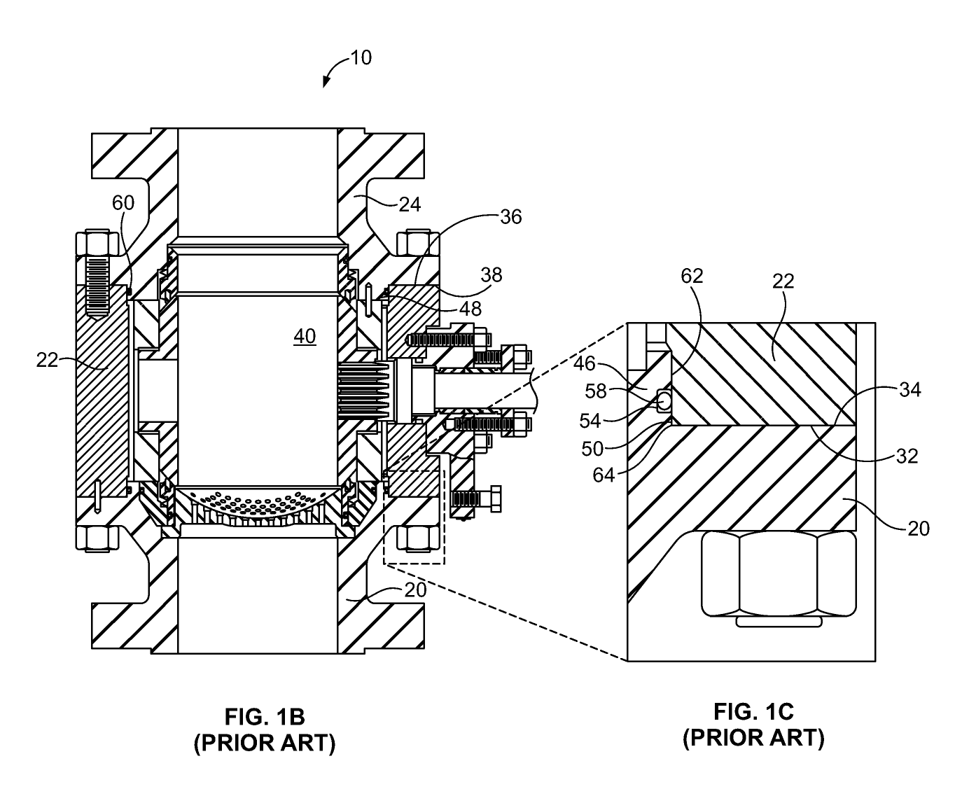

An exploded cross-sectional view of a known multi-section valve is shown in FIG. 1A. The valve 10, which may be, for example, the V260 ball valve made by Fisher®, a division of Emerson Process Management of St. Louis, Mo., includes a valve body composed of three separate bodies (e.g., portions, sections, pieces, components): a first tailpiece 20, a body 22 (e.g., a middle body section) and a second tailpiece 24. The body 22 includes a ball 26, a shaft 28 coupled to the ball 26, and a dome attenuator 30, which conditions fluid flow (e.g., reduces noise and/or cavitation in the fluid flow). The first tailpiece 20 has a first face 32 for engaging a first end 34 of the body 22. The second tailpiece 24 has a second face 36 for engaging a second end 38 of the body 22. When assembled, the three bodies 20-24 form a passage 40 between an inlet 42 and an outlet 44 of the valve 10. The three bodies 20-24 are coupled together via mechanical fasteners, such as, for example, bolts, or any other mechanical fastener(s).

The first and second tailpieces 20 and 24 include respective male extensions 46 and 48 with annular walls 50 and 52. The male extensions 46 and 48 guide the first and second tailpieces 20 and 22 into the body 22 to ensure proper alignment. The first and second annular walls 50 and 52 include respective glands 54 and 56 for holding seals 58 and 60. The first and second seals 58 and 60 create a seal between the first and second annular walls 50 and 52 and an inner surface 62 (e.g., a bore) of the body 22 to prevent the leakage of process fluids from the valve 10. The glands 54 and 56 also assist in seal retention during assembly such as, for example, during vertical assembly where the seal may move due to gravity.

An assembled cross-sectional view of the known multi-section valve 10 is shown in FIG. 1B. As shown, the first and second tailpieces 20 and 24 are coupled to the body 22 to form the ball valve 10 and define the passageway 40 through the valve 10. An enlarged cross-sectional view shown in FIG. 1C highlights the interface (e.g., the boundary) between the first annular wall 50 and the inner surface 62 of the body 22. During assembly, the body 22 slides over the first male extension 46 such that the first end 34 of the body 22 engages the first face 32 of the first tailpiece 20. The second tailpiece 24 slides onto the body 22 such that the second face 36 engages the second end 38 of the body and the second male extension 48 is slid into the body 22 (FIG. 1B). The first and second seals 58 and 60 create a seal between the first and second tailpieces 20 and 24 and the body 22.

However, this type of seal configuration can present difficulties when assembling and operating the valve. As can be appreciated from FIGS. 1A-1C, the tolerances between the size of the body 22 and the first male extension 46 must be very strict so that seal 58 is compressed enough to ensure proper sealing between the first tailpiece 20 and the body 22. The squeeze of the seal is also affected by the depth and, therefore, the tolerance of the gland 54. The gap between the annular walls 50 and 52 and the inner surface 62 of the body 22 must be large enough to enable assembly of the valve body sections 20-24 but small enough to ensure proper o-ring squeeze or compression. Therefore, proper o-ring squeeze is highly dependent on the tolerances and final dimensions of the male extensions 46 and 48, the inner surface 62 of the body 22, and the depth of the glands 54 and 56 and, thus, these tolerances and dimensions must be very strict. For example, certain V260 ball valve tailpieces having a 37.470 inch nominal gland dimension have a +/−0.002 inch tolerance.

During assembly, because this type of seal is a static seal, the relative movement between the tailpieces 20 and 24 and the body 22 often damages the seals 58 and 60. For example, as shown in FIG. 1C, an edge 64 between the first end 34 and the inner surface 62 of the body 22 often catches (e.g., snags, grips, grabs) and damages the seal 58. In another example, the friction between the seal 58 and the inner surface 62 of the body 22 may damage and/or remove the seal 58 from the annular gland 54. With larger valves, which must be assembled vertically (e.g., by a crane operator), these errors are difficult to detect. Also, during operation, pressure from the process fluid pushes against the seal 58 and often forces the seal 58 to migrate from the gland 54 down into the gap where it loses its intended function.

The example multi-section valve bodies described herein have lower tolerance requirements, reduce seal damage during assembly, prevent seal extrusion during high pressure operation, and greatly reduce manufacturing and maintenance costs. In general, the example multi-section valve bodies described herein include a valve body composed of three bodies (e.g., portions, sections, pieces, components), specifically, first and second tailpieces coupled to opposites sides of a body (e.g., a middle body section). The first and second tailpieces have male extensions that extend into a bore of the body and faces with annular glands that seal against respective ends of the body. In some examples, a half-dovetail gland is formed in the faces to retain a seal (e.g., an o-ring) during assembly. The example multi-section valve bodies described herein utilize a face-type seal. Throughout this description, the example multi-section valve bodies are referred to as example ball valves. However, the teachings of this disclosure may be applied to any type of valve body having multiple bodies (e.g., portions, section, pieces, components) and, more particularly, to multi-section valve bodies capable of accommodating face-type seals.

In particular, an example multi-section valve body described herein includes first and second tailpieces coupled to first and second ends of a body. The body includes a number of flow control components (e.g., a flow control member, a seal, a shaft, a spherically-shaped disk, a bearing, etc.). The first and second tailpieces include sealing faces for sealingly engaging respective ends of the body. The first and second tailpieces also include male extensions, which extend into a bore of the body when the first and second tailpieces are coupled to the respective ends of the body.

The first and second tailpieces also include annular glands (e.g., grooves, cavities) defined in the respective sealing faces. The glands receive seals such as, for example, o-ring type seals for creating a sufficiently tight seal between the sealing faces and the respective ends of the body to prevent the leakage of process fluid. The annular glands defined in the sealing faces of the tailpieces, as opposed to those defined in annular walls of the male extensions, reduce tolerance requirements between the diameter of the inner surface of the body and the outer diameter of the male extensions. The faces of the tailpieces may be compressed tightly onto the ends of the body and, thus, any remaining gap is eliminated and a full seal gland (e.g., a four sided gland) is formed.

In some examples, the annular glands are Parker half-dovetail or full-dovetail style glands. The example multi-section valve bodies described herein are also effective in extremely high pressure systems because the location of the seal, and elimination of a gap, prevents the seals from being forced out of the glands due to process fluid pressure.

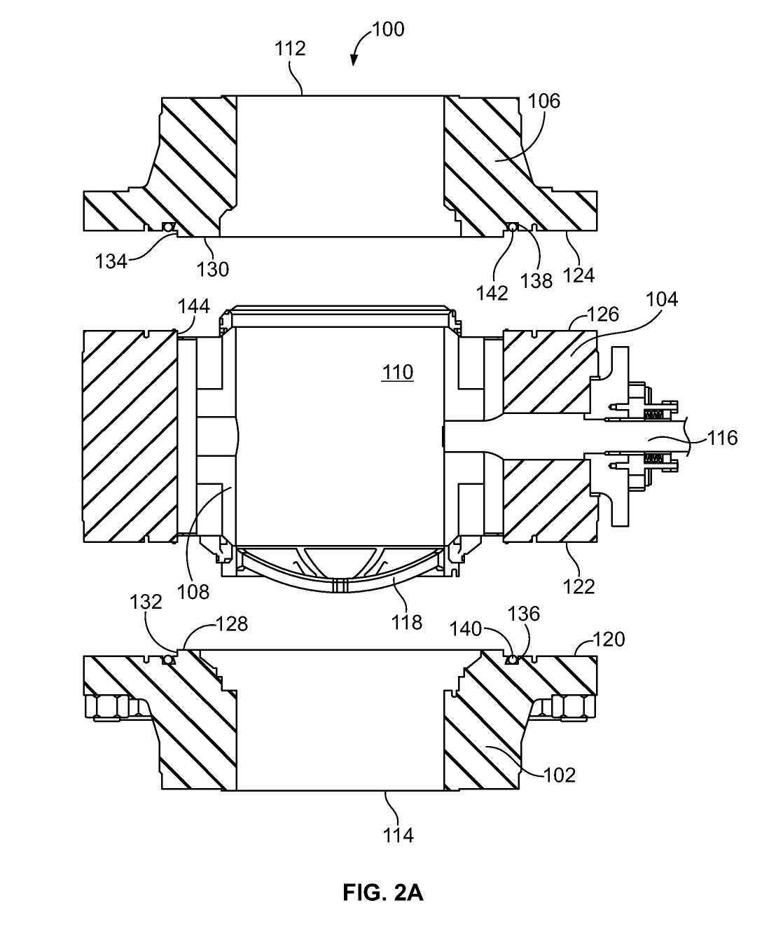

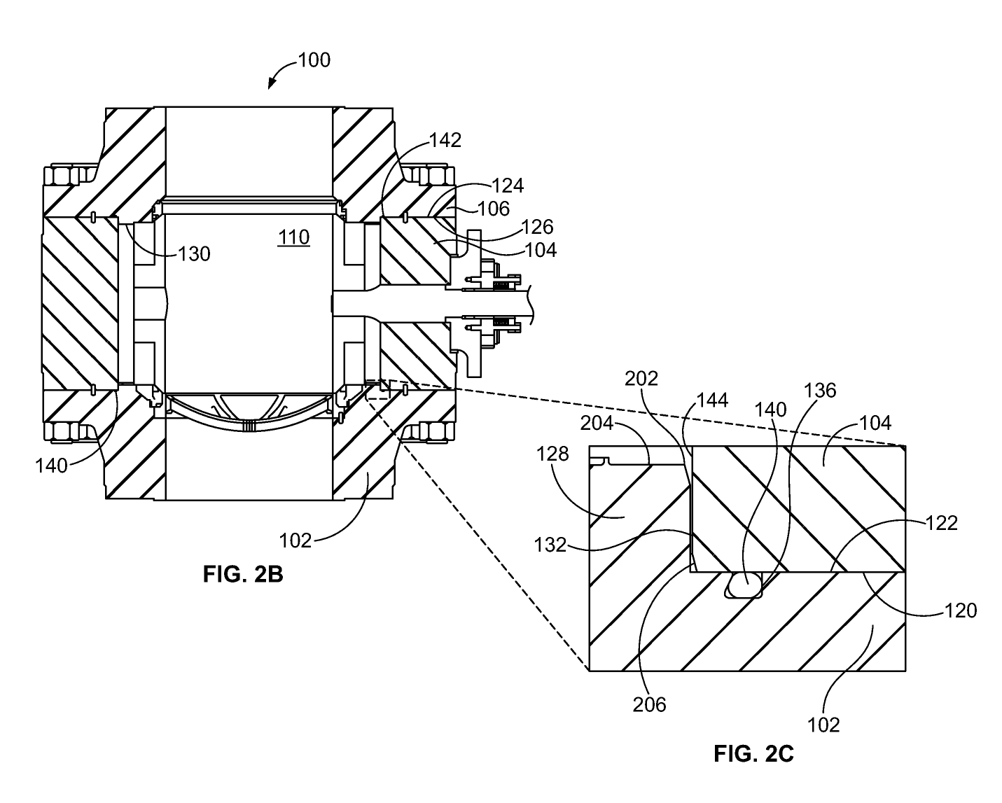

FIG. 2A is an exploded cross-sectional view of an example multi-section valve body 100 described herein. The multi-section valve 100 shown may be, for example, a ball valve and may be used to control the flow of process fluids, such as natural gas, oil, water, etc. The multi-section valve body 100 includes three bodies (e.g., portions, sections, pieces, components): a first tailpiece 102, a body 104, and a second tailpiece 106. The valve 100 also includes a ball 108 (e.g., a movable flow control member, a spherical disk). When coupled together, the first and second tailpieces 102 and 106 and the body 104 define a passageway 110, along a fluid flow axis or longitudinal axis, between an inlet 112 and an outlet 114 when the valve 100 is installed in a fluid process system (e.g., a distribution piping system). In the examples described herein, the inlet 112 and the outlet 114 may either be an inlet or an outlet for the flow of process fluids through the valve 100 depending on the direction of fluid flow through the valve 100.

The body 104 also includes a shaft 116 coupled to the ball 108, and a dome attenuator 118 which, for example, may be used to condition fluid flow (e.g., reduce noise and/or cavitation in the fluid flow). The first tailpiece 102 has a first face 120 (e.g., a flange, a sealing surface) for engaging a first end 122 of the body 104. The second tailpiece 106 has a second face 124 for engaging a second end 126 of the body 104. In the example shown, the first and second faces 120 and 124 are substantially perpendicular to the passageway 110 or fluid flow axis. The three valve body sections 102-106 may be coupled together via mechanical fasteners, such as, for example, bolts, or any other mechanical fastener(s).

The first and second tailpieces 102 and 106 include respective male extensions 128 and 130 with annular walls 132 and 134. The male extensions 128 and 130 extend substantially perpendicular to the first and second faces 120 and 124 and, thus, the annular walls 132 and 134 extend substantially parallel to the passageway 110 or fluid flow axis. The first and second faces 120 and 124 include respective glands 136 and 138 (e.g., annular grooves) for holding seals 140 and 142. The first and second glands 136 and 138 protrude into respective faces 120 and 124 in a direction substantially parallel to the fluid flow axis or longitudinal axis of the valve 100. The first and second seals 140 and 142 create a seal between the first and second faces 120 and 124 and the first and second ends 122 and 126 of the body 104 to prevent the leakage of process fluids from the valve 100. In the example shown, the seals 140 and 142 are o-ring seals. However, in other examples, the seals 140 and 142 may be, for example, spring-loaded seals, elastomeric seals, omni-seals, gaskets (e.g., flat gaskets, spiral wound gaskets, etc.), or any other type of seal capable of being compressed or deformed. The body 104 has an inner bore surface 144 to receive the first and second annular walls 132 and 134 of the respective tailpieces 102 and 106.

An assembled cross-sectional view of the multi-section valve 100 is shown in FIG. 2B. As shown, the first and second tailpieces 102 and 106 are coupled to the body 104 to form the valve 100 and define the passageway 110 through the valve 100. An enlarged cross-sectional view shown in FIG. 2C highlights the interface (e.g., the boundary) between the first face 120 of the first tailpiece 102 and the first end 122 of the body 104. During assembly, the body 104 slides over the first male extension 128 such that the first end 122 of the body 104 engages the first face 120 and, thus, the first seal 140 in the first gland 136 of the first tailpiece 102. The second tailpiece 106 slides onto the body 104 such that the second face 124 engages the second end 126 of the body 104 and the second male extension 130 is slid into the body 104 (FIG. 2B). The first and second seals 140 and 142 create a seal between the first and second tailpieces 102 and 106 and the body 104. In the example shown, during vertical assembly, the profile of the gland 138 prevents the seal 142 from falling out of the gland 138 as the second tailpiece 106 is lowered down onto the body 104.

Unlike the male o-ring gland style tailpieces described above in FIGS. 1A-1C, the bodies 102-106 of the multi-section valve 100 require no sliding interaction between surfaces of the multi-section valve 100 and the seals 140 and 142. The static interaction with the seals 140 and 142 reduces the risk of seal damage during assembly. During assembly the first and second ends 122 and 126 of the body 104 engage the first and second faces 120 and 124 and, thus, the seals 140 and 142. The mechanical fasteners (e.g., bolts) used to assemble the multi-section valve body 100 may be tightened to compress or deform the seals 140 and 142 and create a sufficiently tight seal between the tailpieces 102 and 106 and the body 104.

As illustrated in FIG. 2C, a first edge 202 between the first annular wall 132 and an end 204 of the first male extension 128 may be tapered. The tapered profile of the first edge 202 may, for example, assist in alignment during assembly when coupling the first tailpiece 102 and body 104. Further, as shown, a second edge 206 between the first end 122 and the inner bore surface 144 may also be tapered. The tapered profile of the second edge 206 also assists in assembly when coupling the first tailpiece 102 and the body 104. Although the tapered edges 202 and 206 are shown in connection with the first tailpiece 102, similar tapers may be used on the second tailpiece 106 to facilitate its interface with the body 104.

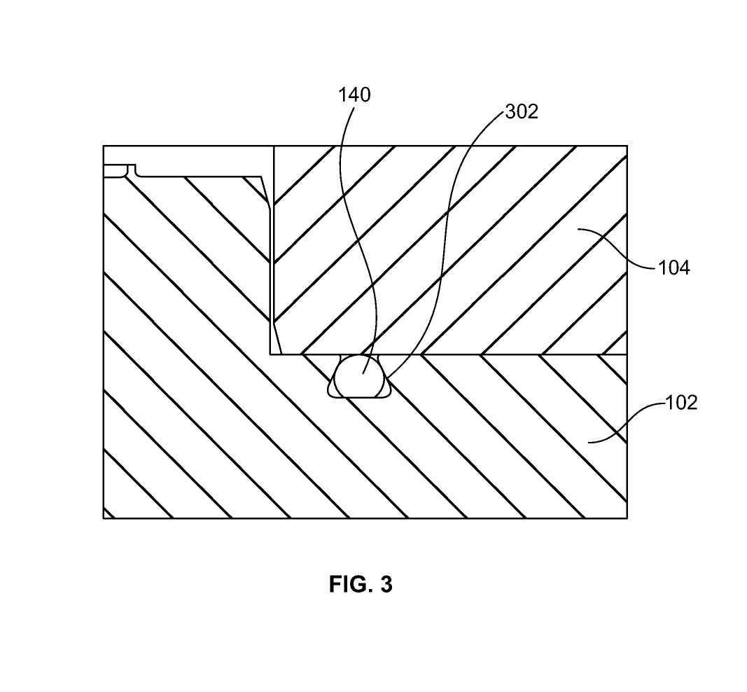

As shown, the first and second annular glands 136 and 138 are Parker half-dovetail glands. In the example shown, the half-dovetail glands 136 and 138 are defined by three walls, one of which is tapered inward. The tapered profile of the glands keeps the seals 140 and 142 within the glands 136 and 138 during, for example, assembly of the valve body 100. For example, with larger valves, the second tailpiece 106 may be lowered down onto the body 104 and the profile of the gland 138 retains the seal 142 within the gland 136 to ensure proper assembly. In other examples, the first and second annular glands 136 and 138 may be full Parker dovetail glands, or any other shaped gland for receiving a seal and retaining the seal in the gland. FIG. 3 illustrates an enlarged cross-sectional view of the interface between the first tailpiece 102 and the body 104. As shown, the interface uses a gland 302 having a full Parker dovetail configuration for retaining the seal 140.

The example valve 100 having multiple bodies described herein has lower tolerance requirements, reduces seal damage during assembly, prevents seal extrusion during high pressure operation, and greatly reduces manufacturing and maintenance (e.g., weld repair) costs. The face seal and profiled gland provide more effective sealing than a male gland type seal and assist in seal retention during assembly. The example multi-section valve 100 also decreases tolerance stack-up that affect o-ring squeeze. With improved o-ring squeeze, the example multi-section valve body provides more optimum (e.g., reliable) operating life and, thus, lower maintenance costs.

Although certain example apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An apparatus comprising:
a first body defining a first portion of a valve passageway and having a fluid flow axis, the first body having a first sealing surface substantially perpendicular to the fluid flow axis and a first annular wall substantially parallel to the fluid flow axis, the first body having an annular cavity defined in the first sealing surface to receive a seal; and
a second body having a bore defining a second portion of the valve passageway, the second body having a first end surface to be substantially parallel to the first sealing surface, wherein the first sealing surface is to engage the first end surface and the first annular wall is to extend into the bore of the second body when the first body is coupled to the second body.

2. The apparatus as defined in claim 1, further comprising the seal and wherein the seal comprises an o-ring.

3. The apparatus as defined in claim 1, wherein the annular cavity has three sides.

4. The apparatus as defined in claim 3, wherein the annular cavity comprises a dovetail groove.

5. The apparatus as defined in claim 3, wherein the annular cavity comprises a half-dovetail groove.

6. The apparatus as defined in claim 5, wherein an angled side of the half-dovetail groove is nearest the valve passageway.

7. The apparatus as defined in claim 1, wherein a first edge between the bore and the first end surface of the second body is tapered.

8. The apparatus as defined in claim 1, wherein at least a portion of the first annular wall is tapered.

9. The apparatus as defined in claim 1 further comprising a third body having a second sealing surface to be substantially parallel to a second end surface on the second body, the second sealing surface having a second annular cavity to receive a second seal, wherein the second sealing surface is to engage the second end surface when the third body is coupled to the second body.

10. The apparatus as defined in claim 9, wherein the second annular cavity comprises one of a dovetail groove or a half-dovetail groove.

11. The apparatus as defined in claim 9, wherein the second sealing surface has a second annular wall substantially parallel to the fluid flow axis and the second annular wall is to extend into the bore of the second body when the second body and the third body are coupled.

12. A valve body comprising:
a first tail portion defining a first portion of a passageway and having a first flange with a first annular groove, the first annular groove extending into the first flange in a direction substantially parallel to a longitudinal axis of the passageway, the first tail portion having a first annular wall section extending from the first flange;
a second tail portion defining a second portion of the passageway and having a second flange with a second annular groove, the second annular groove extending into the second flange in a direction substantially parallel to the longitudinal axis of the passageway, the second tail portion having a second annular wall section extending from the second flange; and
a valve portion having a bore defining a third portion of the passageway, the valve portion having a first end surface and a second end surface opposite the first end surface, wherein the first flange engages the first end surface and the first annular wall section extends into at least a portion of the bore, and wherein the second flange engages the second end surface and the second annular wall section extends into a least a portion of the bore.

13. The valve body as defined in claim 12, wherein the first annular groove comprises one of a dovetail groove or a half-dovetail groove.

14. The valve body as defined in claim 13, wherein the second annular groove comprises one of a dovetail groove or a half-dovetail groove.

15. The valve body as defined in claim 12, wherein a first edge between the bore and the first end surface of the valve portion is tapered.

16. The valve body as defined in claim 15, wherein a second edge between the bore and the second end surface of the valve portion is tapered.

17. The valve body as defined in claim 12, wherein at least a portion of the first annular wall is tapered.

18. The valve body as defined in claim 17, wherein at least a portion of the second annular wall is tapered.

19. The valve body as defined in claim 12, wherein the valve portion comprises a spherically-shaped disk for controlling a flow of fluid through the valve.

20. An apparatus comprising:
a first body defining a first portion of a valve passageway and having a fluid flow axis, the first body having a first sealing surface substantially perpendicular to the fluid flow axis and a first male extension extending from the first sealing surface;
a second body defining a second portion of the valve passageway, the second body having a second sealing surface substantially perpendicular to the fluid flow axis and a second male extension extending from the second sealing surface;
a third body having a bore defining a third portion of the valve passageway, the third body having a first end surface to be substantially parallel to the first sealing surface and a second end to be substantially parallel to the second sealing surface;
first means for sealing to prevent a flow of fluid between the first sealing surface of the first body and the first end of the third body when the when the first body is coupled to the third body; and
second means for sealing to prevent the flow of fluid between the second sealing surface of the second body and the second end of the third body when the second body is coupled to the third body.
